(19) United States
(12) Patent Application Publication
(10) Pub. No.: US 2021/0133726 A1
(43) Pub. Date: May 6, 2021

(54) TRANSACTION SUPPORT PROGRAM AND SYSTEM

(71) Applicants: Yoshimitsu KAGIWADA, Ashigarakamigun Matsudamachi, Kanagawa (JP); KEYSOFT, INC., Ashigarakamigun Matsudamachi, Kanagawa (JP)

(72) Inventor: Yoshimitsu KAGIWADA, Ashigarakamigun Matsudamachi (JP)

(73) Assignees: Yoshimitsu KAGIWADA, Ashigarakamigun Matsudamachi, Kanagawa (JP); KEYSOFT, INC., Ashigarakamigun Matsudamachi, Kanagawa (JP)

(21) Appl. No.: 16/491,574

(22) PCT Filed: Mar. 8, 2018
(86) PCT No.: PCT/JP2018/009111

§ 371 Date: Apr. 15, 2020

(30) Foreign Application Priority Data
Mar. 8, 2017 (JP) 2017-044437

(51) Int. Cl. G06Q 20/34; G06Q 20/32; G06Q 20/40; G06Q 30/02

(52) U.S. Cl. CPC G06Q 20/353; G06Q 20/341; G06Q 30/0236; G06Q 20/4014; G06Q 20/409; G06Q 20/3223

(57) ABSTRACT

The disclosure relates to, inter alia, a transaction support program and system for a portable device. When the program is executed, the reading portion of a portable device reads IC storage information stored in an external IC chip. An acquisition portion acquires information for transaction. A communication portion transmits the information for transaction to an external transaction support system so as to perform a transaction. At least part of the information for transaction is acquired based on the IC storage information read with the reading portion.

### TECHNICAL FIELD

The present invention relates to a portable device for transactions and the like, and more particularly relates to a portable device which reads information stored in an external IC chip in order to perform transactions and the like.

### BACKGROUND ART

When an IC card is used for a transaction, it is necessary to make an IC card reader read information, and thus the IC card needs to be used within a store of a trader or within a facility thereof in which the IC card reader is installed. Hence, places in which IC cards can be used for transactions are limited.

Although as disclosed in non-patent document 1, a system is present in which an external accessory is connected to a portable device so as to read an IC card, the system is prepared for traders, and thus the system is not possessed by each payer for personal use. It is inconvenient that in order for the system to be used in any place, the external accessory needs to be constantly carried. Although the system differs in connection interface from a conventional card reader which is connected by wire to a personal computer, they are the same in that they are connected externally. In addition, it is necessary to purchase the card reader in advance, and thus, it is costly to do so.

### PRIOR ART DOCUMENT

### Non-Patent Document

Non-patent document 1: Square, “Let's get started, credit card payment with Square”, [online], [Searched on Mar. 7, 2017], The Internet <URL: https://squareup.com/jp>

### SUMMARY OF THE INVENTION

### Problem to be Solved by the Invention

An object of the present invention is to enable an IC chip mounted in an IC card or the like to be used for transactions without limitation of places. Another object is to realize it with a single portable device such as a smart phone without need of an external accessary or the like.

### Means for Solving the Problem

In order to solve these objects, a portable device of the present invention incorporates, in a portable main body, a reading portion which reads IC storage information from an IC chip, an acquisition portion of information for transaction and a communication portion which transmits the information for transaction to a transaction support system so as to perform a transaction. The acquisition portion of the information for transaction acquires at least part of the information for transaction based on the IC storage information read with the reading portion.

In a situation where a transaction is performed, regardless of the place thereof, the reading portion of the portable device is made to read the IC storage information of the IC chip, and thus the acquisition portion acquires at least part of the information for transaction. The acquisition portion may acquire all the information for transaction based on the IC storage information or may acquire only part of the information for transaction based on the IC storage information and acquire the other parts of the information for transaction through a UI (user interface) or the like. Then, the information for transaction acquired in the acquisition portion is provided through the communication portion to the transaction support system. The transaction support system utilizes the information for transaction received from the portable device for processing necessary for performing the transaction.

### Effect of the Invention

Hence, according to the present invention, an IC chip mounted in an IC card or the like can be used for transactions without limitation of places.

### BRIEF DESCRIPTION OF THE DRAWINGS

FIG. 1 is a configuration diagram illustrating a first embodiment of the present invention;

FIG. 2 is a configuration diagram illustrating a second embodiment of the present invention;

FIG. 3 is a data structure diagram of information which is used for processing in the payment agency system of FIG. 2;

FIG. 4 is a configuration diagram of the payment agency system shown in FIG. 2;

FIG. 5 is a flowchart of payment request processing which is performed in the payment agency system of FIG. 2;

FIG. 6 is a flowchart of payment reception processing which is performed in the payment terminal of FIG. 2;

FIG. 7 is a configuration diagram illustrating a third embodiment of the present invention;

FIG. 8 is a configuration diagram illustrating a fourth embodiment of the present invention;

FIG. 9 is a configuration diagram illustrating a fifth embodiment of the present invention;

FIG. 10 is a configuration diagram illustrating an eighth embodiment of the present invention; and

FIG. 11 is a configuration diagram illustrating a variation of the third embodiment.

### MODE FOR CARRYING OUT THE INVENTION

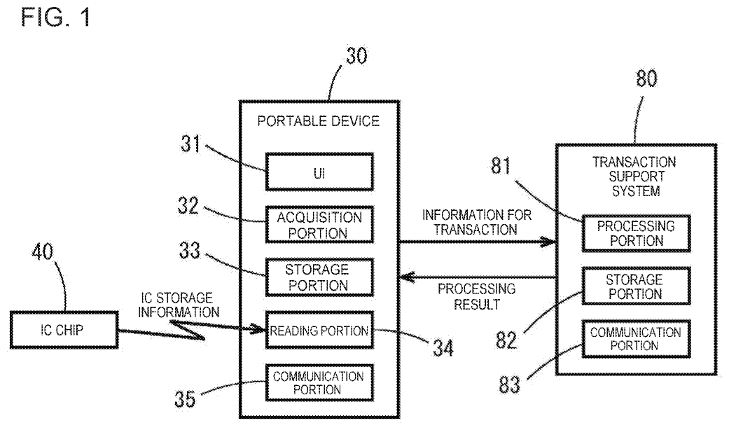

A first embodiment of the present invention is shown in FIG. 1. In FIG. 1, a portable device 30 acquires information for transaction based on IC storage information read from an IC chip 40, and transmits the information for transaction to a transaction support system 80. The transaction support system 80 utilizes the information for transaction received from the portable device 30 for processing necessary for performing a transaction.

The portable device 30 incorporates, in a portable main body, a reading portion 34 which reads the IC storage information from the IC chip 40, an acquisition portion 32 for the information for transaction and a communication portion 35 which transmits the information for transaction to the transaction support system in order to perform the transaction. The acquisition portion 32 for the information for transaction acquires at least part of the information for transaction based on the IC storage information read by the reading portion 34. The portable device 30 also includes a UI (user interface) 31 and a storage portion 33.

More specifically, in the present embodiment, the portable device 30 is, for example, a smart phone, a tablet terminal or the like. The UI 31 is, for example, a touch panel, and includes an input device and a display device. A processor executes a program so as to realize the acquisition portion 32. The storage portion 33 includes a storage device such as a flash memory, and performs the writing and reading of information involved in the execution of a program. The reading portion 34 includes an IC reader/writer corresponding to the IC chip 40. The communication portion 35 has the function of communicating with an external computer through a computer network such as the Internet.

The transaction support system 80 includes a processing portion 81, a storage portion 82 and a communication portion 83. A processor executes a program so as to realize the processing portion 81, and the processing portion 81 performs various types of processing so as to support the performance of the transaction. Examples of the processing for supporting the performance of the transaction include credit payment processing, wire transfer processing, payment agency processing and identification processing. The storage portion 82 includes a storage device such as a hard disk drive, and performs the writing and reading of information involved in the execution of a program. The communication portion 83 has the function of communicating with an external computer through a computer network such as the Internet.

When the transaction is performed, the user of the portable device 30 makes the reading portion 34 of the portable device 30 read the IC storage information stored in the IC chip 40. The acquisition portion 32 stores, as the information for transaction, in the storage portion 33, the IC storage information received by the reading portion 34. The acquisition portion 32 acquires the information for transaction associated with the IC storage information through the communication portion 35 from an external storage device, and stores it in the storage portion 33. The acquisition portion 32 receives, as necessary, an input of the information for transaction through the UI 31 from the user, and stores it in the storage portion 33. Then, the acquisition portion 32 reads the information for transaction stored in the storage portion 33, and transmits it through the communication portion 35 to the transaction support system 80. All the information for transaction which is transmitted may be information acquired based on the IC storage information or the information for transaction which is transmitted may include, as part thereof, information acquired based on the IC storage information.

The processing portion 81 of the transaction support system 80 acquires, through the communication portion 83, the information for transaction transmitted from the portable device 30, and stores it in the storage portion 82. Thereafter, the processing portion 81 may utilize the information for transaction stored in the storage portion 82 so as to perform predetermined processing necessary for performing the transaction, and transmit the result of the processing through the communication portion 83 to the portable device 30 which is the transmission source of the information for transaction.

The portable device 30 receives, through the communication portion 35, the result of the processing transmitted from the transaction support system 80, and displays, in the UI 31, information based on the result of the received processing.

Specifically, the portable device 30 may acquire payment information such as a credit card number from the IC chip 40, and the transaction support system 80 may perform payment processing based on the payment information. The portable device 30 may acquire the payment information of a remittance source based on the IC storage information read from the IC chip 40, and acquire the account information of a wire transfer destination which is input from the UI 31, and the transaction support system 80 may perform wire transfer processing from the remittance source to the remittance destination based on the payment information of the remittance source and the account number of the wire transfer destination. The portable device 30 may acquire personal information of the user from the IC chip 40, and the transaction support system 80 may compare the personal information with previously registered true personal information so as to perform the identification of the user, and display the result thereof in the portable device 30. It is possible to advance the transaction according to the result of the identification.

In the present embodiment, the portable device 30 is made to read the information stored in the IC chip 40 so as to perform the processing necessary for performing the transaction, and thus it is possible to use, for the transaction, the IC chip mounted in the IC card or the like regardless of places.

A second embodiment of the present invention will then be described. Although credit cards in which IC chips are mounted are widely available, when it is desired to perform a credit card payment in online shopping, it is necessary to input the information of the credit card to an online shop. However, there are some users who are worried about the inputting of the information of the credit card to the online shop.

For example, there is a case where a credit card number is previously registered in a shopping site. There is also a case where each time shopping is performed, a credit number is input and transmitted to a shopping site. Here, in a method which is normally performed, a credit card number, the name of a card holder, an expiration date and a security code are input to a screen and are transmitted, and thus it is possible to perform a payment. Hence, even when an actual card is not present, if a credit card number, the name of a card holder, an expiration date and a security code in another person's card are written as a memo, are memorized and are obtained by any method, anyone can easily perform a credit payment in the name of the other person, with the result that this method is extremely dangerous. In the current method described above, once payment information registered in a shopping site leaks out, anyone in the world can use the information which has leaked out so as to perform a payment, with the result that the damage may be greatly expanded. There is a slight possibility that a site operator abuses the payment information of another person which can be obtained. As described above, when payment information leaks out, others can utilize the payment information so as to easily perform shopping and receive the provision of services.

Hence, in the present embodiment, an object is to apply the first embodiment such that the purchaser of a commodity or the like can perform an IC card payment without disclosing IC card information to a shop system.

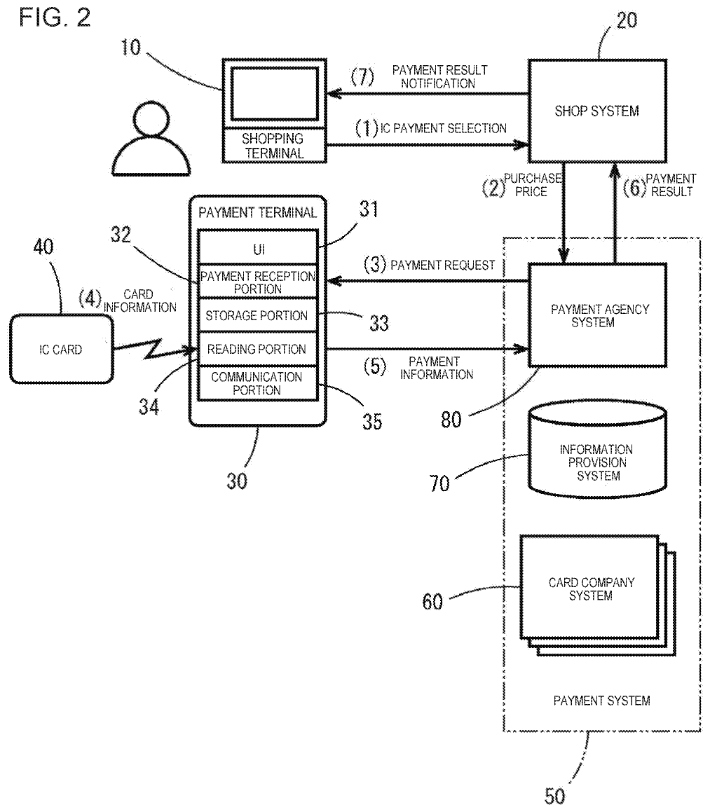

The second embodiment of the present invention is shown in FIG. 2. The same parts as in the first embodiment are identified with the same reference numerals, and repeated description will be omitted. In the present embodiment, a commodity or a service in a shop system 20 (online shopping site) is purchased with a shopping terminal 10, and the payment of the price thereof is performed with a payment terminal (portable terminal) 30 separate from the shopping terminal 10. The payment is performed with the IC card (IC chip) 40 of a credit card or the like which is placed on the payment terminal 30. The processing of the payment is performed with a payment system 50.

The shopping terminal 10 is a personal computer, a tablet terminal, a smart phone or the like, communicates through a computer network such as the Internet and thereby can purchase a commodity or a service (hereinafter referred to as the “commodity or the like”) which is sold in the shop system 20. The shopping terminal 10 includes constituent elements of a general computer, that is, an UI (user interface), a processor, a storage device and a communication device.

The shop system 20 incudes a server which provides a shopping site, communicates through a computer network such as the Internet and thereby can make the shopping terminal 10 utilize the shopping site and the payment system 50. The shop system 20 includes constituent elements of a general server computer, that is, a processor, a storage device and a communication device.

The payment terminal 30 is a smart phone, a tablet terminal or the like which includes an IC card reader (reading portion). The payment terminal 30 includes a UI 31, a payment reception portion (acquisition portion) 32, a storage portion 33, a reading portion 34 and a communication portion 35. The UI 31 is a touch panel or the like, and displays information for the user of the payment terminal 30, and receives an input of information from the user. A processor executes an application program (application) so as to realize the payment reception portion 32, and the payment reception portion 32 receives a payment procedure for the price of the commodity or the like which is purchased with the shopping terminal 10. The storage portion 33 includes a storage device, and performs the storage and reading of information involved in the processing of the payment reception portion 32. The reading portion 34 includes a reader/writer for reading and writing the information of the IC chip. The communication portion 35 includes a communication device for communicating through a computer network such as the Internet.

The IC card 40 (IC mounting item) includes the IC chip, and stores, in the IC chip, card information necessary for a transaction. The IC mounting item refers to an item which includes the IC chip and in which information used for performing the transaction such as a payment is stored in the IC chip. The form of the IC mounting item is not limited to a card type, and a key holder or a device such as a smart phone which incorporates an IC chip may be adopted.

In the present embodiment, the payment system 50 is a generic name which includes a card company system 60, an information provision system 70 and a payment agency system (transaction support system) 80. The card company system 60 is provided for each card company, and the card company system 60 corresponding to the IC card 40 used for the payment performs an operation such as authorization with the payment agency system 80. The information provision system 70 stores various types of information which are used in the payment agency system 80 for the processing, and provides them to the payment agency system 80. The payment agency system 80 processes the payment of a purchase price instead of the shop system 20.

However, it can be considered that these series of flow steps are performed by the card company system 60 itself without intervention of the payment agency system 80, and in this case, it can be considered that the same processing as that performed in the payment agency system 80 is performed in the same system as the card company system 60. Even in such a case, it can be considered that within the card company, the payment agency system 80 is separately provided, and that thus as will be described later, processing is performed with the two separate systems.

The card company system 60 and the information provision system 70 include constituent elements of a general server computer, that is, a processor, a storage device and a communication device. The processor executes programs so as to realize various operations. The storage device performs the writing and reading of information involved in the processing of the processor. The communication device communicates with other computers through a computer network such as the Internet or a dedicated line.

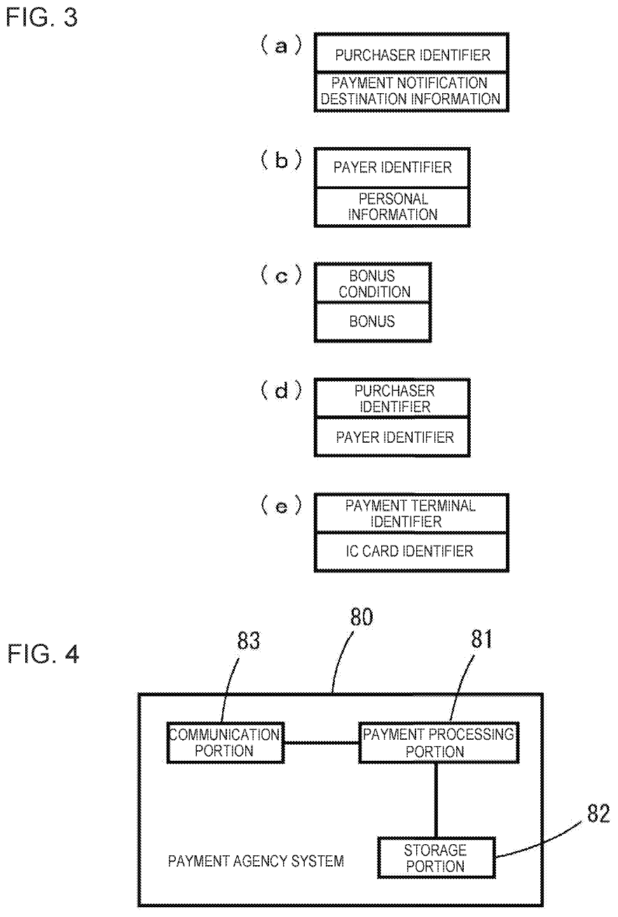

FIG. 3 is a structure diagram of data which is stored in the storage device by the information provision system 70. As shown in FIG. 3(a), the information provision system 70 stores purchaser identifiers and payment notification destination information so as to associate the purchaser identifiers and the payment notification destination information with each other. The purchaser identifier is the identifier of the user of the shopping terminal 10 which utilizes the shop system 20. The purchaser identifier is, for example, the login ID of the user who logs in the shop system 20. The purchaser identifier may be issued by the operator of the shop system 20 or may be issued by the operator of the payment agency system 80. The payment notification destination information is the contact information of the payment terminal 30, and is, for example, the electronic mail address, the SMS telephone number or the like of the payment terminal 30. The payment notification destination information is previously registered for each of the purchaser identifiers. The user of the payment terminal 30 serving as a payment notification destination is not necessarily the same as the user of the shopping terminal 10. For example, the user of the shopping terminal 10 may be a child, and the user of the payment terminal 30 serving as the payment notification destination may be a guardian of the child. A wife can ask her husband to pay an item which she bought, and a lover bought what the lower wanted and can ask the other to pay what the lower bought. In this case, when a commodity or the like is purchased, the shopping terminal 10 may associate the purchaser identifier with the payment notification destination information so as to transmit them. An element of the payment system 50 may directly or indirectly receive the association of the purchaser identifier and the payment notification destination information transmitted from the shopping terminal 10 so as to utilize the association. The data structures of FIGS. 3(b) to 3(e) will be described later.

FIG. 4 is a configuration diagram of the payment agency system 80. The payment agency system 80 includes a payment processing portion (processing portion) 81, a storage portion 82 and a communication portion 83. In the payment processing portion 81, a processor executes programs so as to perform various types of processing. The storage portion 82 includes a storage device, and performs the recording and reading of information involved in the processing of the payment processing portion 81. The communication portion 83 includes a communication device which communicates through a computer network such as the Internet or a dedicated line. The storage portion 82 may store the information shown in FIG. 3 instead of the information provision system 70.

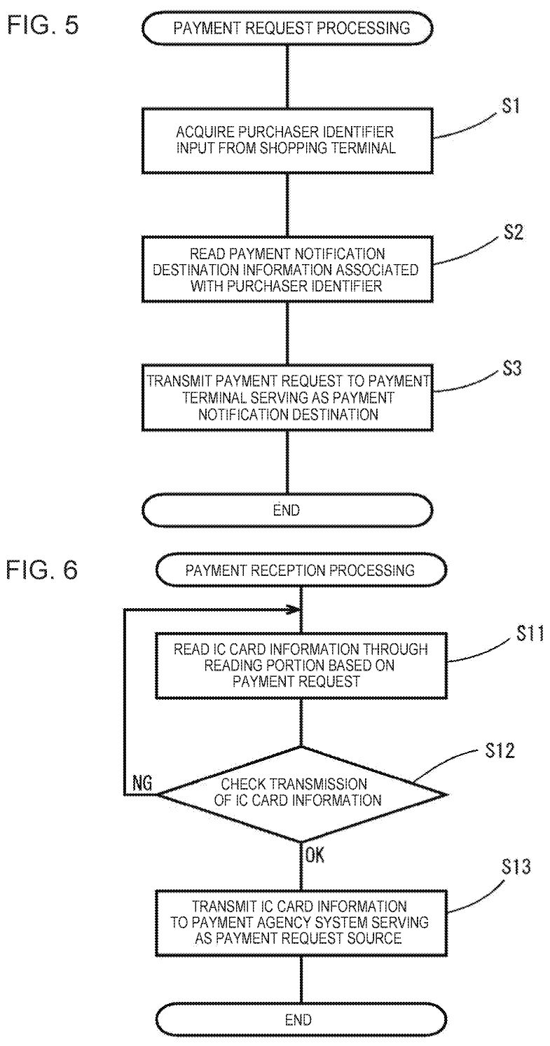

As shown in FIG. 1, the purchaser of a commodity or the like first operates the shopping terminal 10 so as to purchase the commodity or the like from the shop system 20. Here, the purchaser is assumed to select a payment (IC payment) with the IC card 40 (1). The shop system 20 receives the selection of the IC payment from the shopping terminal 10 so as to transmit, to the payment agency system 80, the identifier of the corresponding transaction (transaction identifier), a purchase price, information indicating that the IC payment is performed and the identifier of the purchaser (purchaser identifier) (2). The payment agency system 80 which has received these pieces of information performs payment request processing shown in FIG. 5. The payment processing portion 81 acquires the purchaser identifier from the received information (S1), and acquires the payment notification destination information associated with this purchaser identifier from the information provision system 70 or the storage portion 82 thereof (S2). Then, based on the acquired payment notification destination information, a payment request notification is transmitted to the predetermined payment terminal 30 (S3). The payment request notification includes the transaction identifier and the purchase price. The payment request notification may be delivered to the payment terminal 30, for example, with an electronic mail message or an SMS (short message service) (3).

The payment terminal 30 which has received the payment request notification displays, in the UI 31, information indicating that the payment request is reached. The user (payer) who has confirmed the payment request operates the UI 31 of the payment terminal 30 so as to execute an application for operating the payment reception portion 32. Here, the terminal which has not possessed the application yet downloads and installs the application from the payment agency system or a download center. A configuration may be adopted in which the application is attached to the payment request notification, in which the payment request notification is then transmitted and in which the user of the payment terminal 30 that has received it performs installation processing to the terminal 30.

The payment reception portion 32 which has been brought into an operated state performs payment reception processing shown in FIG. 6. Based on the transaction identifier, the purchase price and the like read from the payment request notification or the payment request notification, the payment reception portion 32 displays, in the UI 31, the transaction identifier, the purchase price and the like received from the payment agency system 80, and the payment reception portion 32 produces a display for prompting the payer to place the payment IC card 40 on the reading portion 34. The payer checks the display so as to place the IC card 40 on the reading portion 34 of the payment terminal 30 such as a smart phone thereof. Then, the payment reception portion 32 reads card information from the IC chip of the IC card 40 placed on the reading portion 34, and stores it in the storage portion 33 (S11). In the present embodiment, the IC card 40 is assumed to be a credit card, and as the card information, a card holder name, a card number, a card expiration date and the like are read (4). Here, input may be performed together with a password or the information of biometric authentication such as a fingerprint. When the payment reception portion 32 reads the card information, the payment reception portion 32 issues a payment sound such as “plink” from a speaker so as to transmit the reading of the card to the user.

Then, before the transmission of the card information to the payment agency system 80, the payment reception portion 32 displays, in the UI 31, the card information, the purchase price, the transaction identifier and the like read from the IC chip, and produces, in the UI 31, a display for prompting the user to check the transmission (S12). When the card used for the payment is not wrong, the user taps a predetermined button of the UI 31 so as to allow the transmission (OK). When the card used for the payment is wrong, the user taps a predetermined button of the UI 31 so as to stop the transmission (NG). In this case, the IC card is read again (S11).

When the transmission of the card information is allowed, the payment reception portion 32 transmits the payment information including the card information, the purchase price and the transaction identifier through the communication portion 35 to the payment agency system 80 (5). Here, the payment reception portion 32 may directly transmit the payment information to the card company system 60 corresponding to the card number. The procedure for the checking by the user in S12 may be omitted, and the card information read in (4) described above may be immediately transmitted by the processing of (5).

The payment agency system 80 which has received the payment information identifies the corresponding card company system 60 based on the card number included in the payment information, and performs authorization with the card company system 60. The payment agency system 80 transmits the result of the authorization (the payment result) to the side of the shop system 20 (6). The payment result includes the corresponding transaction identifier.

However, when the card company system 60 directly receives the payment information from the payment terminal 30, that is, when the processing of the payment agency system 80 and the processing of the card company system 60 are performed in the same or integral system, the processing for identifying the card company system 60 described above is not needed. The payment result may be transmitted not only to the shop system 20 but also to the payment terminal 30.

Here, when the payment information is directly transmitted from the payment terminal 30 to the card company system 60, the payment result is directed transmitted from the card company system 60 to the shop system 20.

The shop system 20 reads the transaction identifier from the received payment result, and makes the shopping terminal 10 corresponding to the transaction identifier produce a display (indicating that the IC payment is completed or that the IC payment cannot be performed) corresponding to the payment result on the screen of the shopping terminal 10 (7). Although in the above description, the shopping terminal 10 and the payment terminal 30 are separate terminals, even if both the terminals are the same, it is also possible to use the same mechanism so as to perform the payment processing.

When the shop system 20 and the payment agency system 80 have received the payment result indicating that the IC payment is completed, they perform sales processing and shipping processing on the corresponding transaction.

In the present embodiment described above, the purchaser of the commodity or the like can perform the IC card payment without disclosing the IC card information to the shop system 20. Since the payment cannot be performed without the main body of the IC card, as compared with a method in which the payment information is passed to the shopping site (purchasing can be performed by obtaining and memorizing the card number and the like of another person even if the card is not present on hand), safety against the abuse of the payment information of other persons is significantly enhanced. The common knowledge that IC cards are used with card readers in stores and facilities is changed, and thus IC cards can be used for online shopping at home, with the result that the applications of IC cards are significantly expanded.

In the embodiment described above, the card company system 60 may transmit the interface of an identification authentication service to the payment terminal 30 which transmits the payment information. In this way, it is possible to realize an operation of automatically accessing the authentication service of the corresponding card company according to the type of IC card 40 which is placed on the payment terminal 30 such as a smart phone.

The payment agency system 80 may perform the identification of the payer. In this case, a payer identifier and personal information of the payer thereof are stored in the storage portion 82 of the payment agency system 80 or the information provision system 70 such that the payer identifier and the personal information of the payer are associated with each other (FIG. 3(b)). The payer identifier is, for example, a login ID for utilizing the application of the payment reception portion 32 or the telephone number of the payment terminal 30. The personal information is personal information which is recorded in the IC chip of a personal card (a personal number card or a citizen card). The payer places a personal card with the IC of the payer on the reading portion 34 of the payment terminal 30. The payment terminal 30 reads the personal information from the IC chip of the personal card which is placed, associates the personal information with the payer identifier stored in the payment terminal 30 and transmits them to the payment agency system 80. The payment agency system 80 searches the storage portion 82 thereof or the information provision system 70 for the same payer identifier as the received payer identifier, and reads personal information associated with the payer identifier found by the search. Then, the payment agency system 80 determines whether or not the read personal information agrees with the personal information received from the payment terminal 30. The payment agency system 80 may request the authorization when the two types of personal information agree with each other.

It can be considered that this identification alone is performed as a completely independent service. In this case, the payment terminal 30 can be called a card reading terminal for identification. The payment agency system 80 can be called an identification system.

When the personal information received from the payment terminal 30 satisfies a preset bonus condition, the payment agency system 80 may provide a bonus to the payer. In this case, the bonus condition and the bonus are previously stored in the storage portion 82 of the payment agency system 80 or the information provision system 70 such that the bonus condition and the bonus are associated with each other (FIG. 3(c)). As the bonus condition, for example, an age condition such as being 70 years old or older can be considered. As the bonus, for example, it can be considered that the purchase price is discounted or that points are provided. The payment agency system 80 determines whether or not the personal information received from the payment terminal 30 satisfies the bonus condition stored in the storage portion 82 or the information provision system 70, and when the personal information satisfies the bonus condition, the payment agency system 80 reads the bonus associated with the bonus condition so as to perform bonus provision processing corresponding to the bonus. In this way, it is possible to provide the bonus corresponding to the personal information of the payer. In the above configuration, the payment agency system 80 may receive, from the payment terminal 30, an identifier such as a card number read from the IC card 40 so as to acquire, from the storage portion 82 or the information provision system 70, personal information which is previously associated with this identifier.

The payment agency system 80 may authenticate the payer by another method. For example, the purchaser identifier and the payer identifier are stored in the storage portion 82 or the information provision system 70 such that purchaser identifier and the payer identifier are associated with each other (FIG. 3(d)). An example of the purchaser identifier and the payer identifier is as described previously. The payment agency system 80 stores, in the storage portion 82, the transaction identifier and the purchaser identifier received from the shop system 20 such that the transaction identifier and the purchaser identifier are associated with each other. Thereafter, the payment agency system 80 stores, in the storage portion 82, the transaction identifier and the payer identifier received from the payment terminal 30 such that the transaction identifier and the payer identifier are associated with each other. Then, the payment agency system 80 determines whether or not a combination of the purchaser identifier and the payer identifier having the common transaction identifier stored in the storage portion 82 is previously registered in the storage portion 82 or the information provision system 70. The payment agency system 80 may determine, on condition that the combination is registered, that user of the payment terminal 30 has a payment authority so as to perform the authorization described previously. In this way, even when the payer who is not associated with the purchaser attempts to perform a payment, it is possible to reject the IC payment thereof.

The payment agency system 80 may authenticate the payer by yet another method. For example, the payment agency system 80 stores the payment terminal identifier of the payment terminal 30 and the IC card identifier of the IC card 40 in the storage portion 82 or the information provision system 70 such that the payment terminal identifier and the IC card identifier are associated with each other (FIG. 3(e)). The payment terminal identifier is the telephone number, the terminal number or the like of the payment terminal 30. The IC card identifier is an IC card number or the like. The payment agency system 80 receives, from the payment terminal 30, the payment terminal identifier and the IC card identifier of the IC card 40. Then, the payment agency system 80 determines whether or not a combination of the payment terminal identifier and the IC card identifier which are received is previously registered in the storage portion 82 or the information provision system 70. The payment agency system 80 may determine, on condition that the combination is registered, that user of the payment terminal 30 has a payment authority so as to perform the authorization described previously. In this way, when the IC card 40 which cannot be used by combination with the payment terminal 30 is used, it is possible to reject the IC payment thereof.

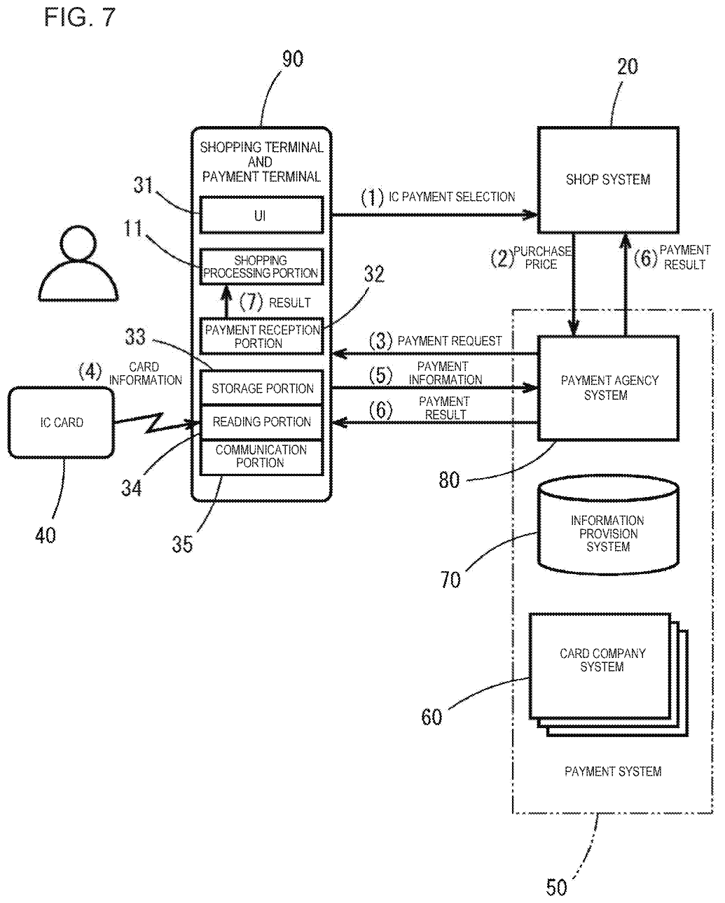

A third embodiment of the present invention will then be described with reference to FIG. 7. The same parts as in the second embodiment are identified with the same reference numerals, and repeated description will be omitted. Although in the second embodiment, the transaction is completed with a plurality of terminals such that the shopping is performed with the shopping terminal 10 and that the payment is performed with the payment terminal 30, in the present embodiment, the transaction is completed with one shopping terminal and payment terminal 90. An operation equivalent to that of the shopping terminal 10 of the second embodiment is performed with a shopping processing portion 11 through the communication portion 35. A processor executes a program so as to realize the shopping processing portion 11.

An operation after the shopping processing portion 11 notifies the selection of the IC payment to the shop system 20 until the payment agency system 80 requests the authorization based on the card information of the IC card 40 is the same as in the second embodiment.

In the present embodiment, the payment agency system 80 transmits the result of the authorization (payment result) not only to the shop system 20 but also to the payment reception portion 32 of the shopping terminal and payment terminal 90 (6). When the payment information of (5) is directly transmitted from the payment terminal 30 to the card company system 60, the card company system 60 directly transmits the payment result to the shop system 20 and the payment reception portion 32.

In the process of the payment reception portion 32, the received payment result is passed by internal communication such as process-to-process communication to the process of the shopping processing portion 11 (7). Based on the payment result passed from the process of the payment reception portion 32, the shopping processing portion 11 produces, in the UI 31, a display (indicating that the IC payment is completed or that the IC payment cannot be performed) corresponding to the payment result. The other operations are the same as in the second embodiment.

In the present embodiment, processing equivalent to that in the second embodiment can be performed with the one shopping terminal and payment terminal 90.

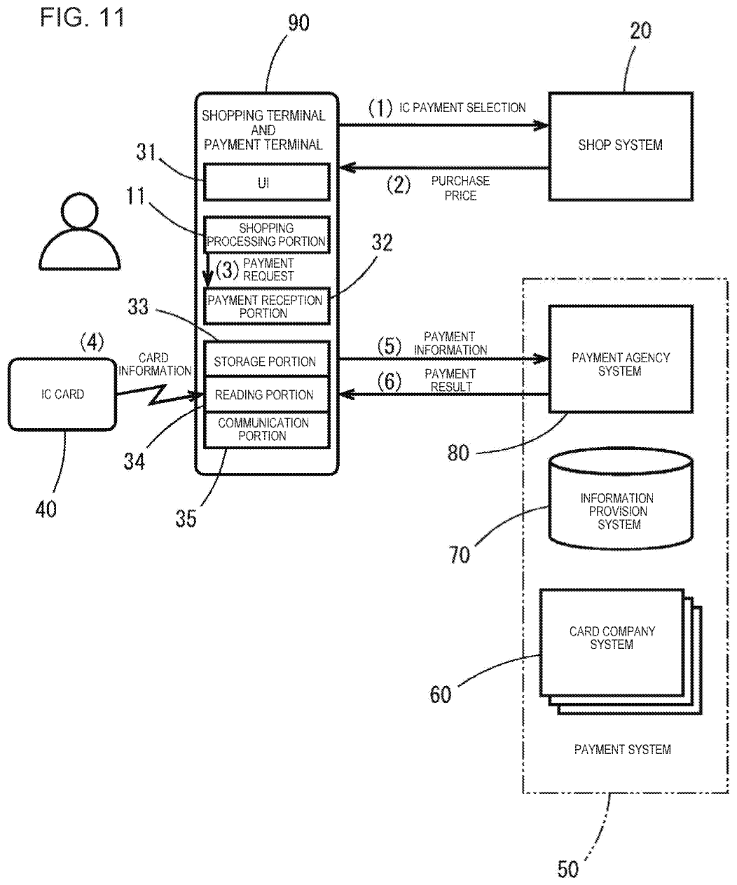

A variation of the third embodiment described above will then be described with reference to FIG. 11. The same parts as in FIG. 7 are identified with the same reference numerals, and repeated description will be omitted.

The user of a shopping terminal and payment terminal (hereinafter referred to as the terminal) operates the UI 31 so as to perform an operation of purchasing a commodity or the like from the shop system 20, and selects the IC payment as a payment method (1). The shop system 20 which has received this selection passes a transaction identifier for uniquely identifying a purchase price and this transaction to the terminal 90 (2). The terminal 90 displays the purchase price and the like in the UI 31. The user checks the price and the like so as to perform an operation of determining the purchase from the UI 31. The shopping processing portion 11 which has received this operation notifies a payment request to the payment reception portion 32 (3). This notification is provided by process-to-process communication within the terminal 90. The payment reception portion 32 which has received the payment request prompts the user to touch the reading portion 34 with the IC card 40, and thus the user touches the reading portion 34 of the terminal 90 with the IC card. The reading portion 34 stores, in the storage portion 33, information for transaction such as a credit card number read from the IC chip of the IC card 40 (4). The payment reception portion 32 transmits, through the communication portion 35, to the payment agency system 80, the information for transaction stored in the storage portion 33 and the payment information including the purchase price and the transaction identifier passed from the shop system 20, and thereby requests a payment (5). The payment reception portion 32 receives the payment result from the payment agency system 80, and displays it in the UI 31. The terminal 90 may notify the payment result to the shop system 20. The payment agency system 80 may notify the payment result to the shop system 20.

By the communication procedure as described above, with the one shopping terminal and payment terminal 90, it is also possible to perform the payment based on the information read from the IC card.

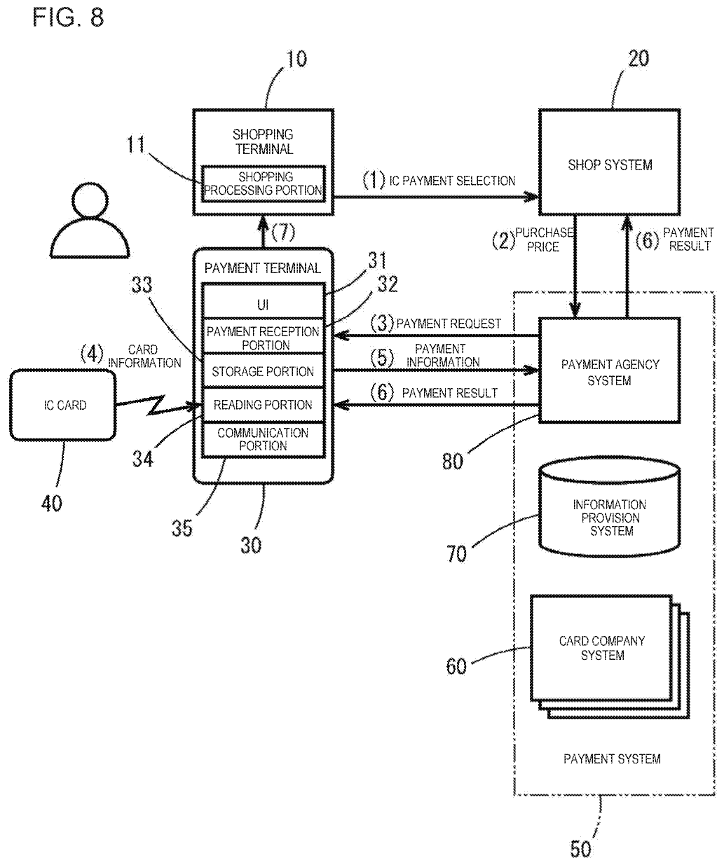

A fourth embodiment of the present invention will then be described with reference to FIG. 8. The same parts as in the embodiments described above are identified with the same reference numerals, and repeated description will be omitted. In the third embodiment described above, within the one shopping terminal and payment terminal 90, the processing for passing the payment result from the process of the payment reception portion 32 to the process of the shopping processing portion 11 by internal communication such as process-to-process communication is performed. In the present embodiment, as in the second embodiment, the shopping terminal 10 and the payment terminal 30 are configured so as to be separated, and the shopping terminal 10 includes the shopping processing portion 11 of the third embodiment. The payment terminal 30 and the shopping terminal 10 are connected by wire with a communication cable such as a USB cable, and through this wired connection, the payment result is passed by a mechanism such as process-to-process communication from the process of the payment reception portion 32 performed in the payment terminal 30 to the process of the shopping processing portion 11 performed in the shopping terminal 10 (7). The other operations are the same as in the third embodiment. In this way, it is also possible to achieve the same effects as in the third embodiment. Here, the connection between the shopping terminal 10 and the payment terminal 30 is not limited to wired connection, and it can be considered that the connection is performed by wireless communication such as Wi-Fi.

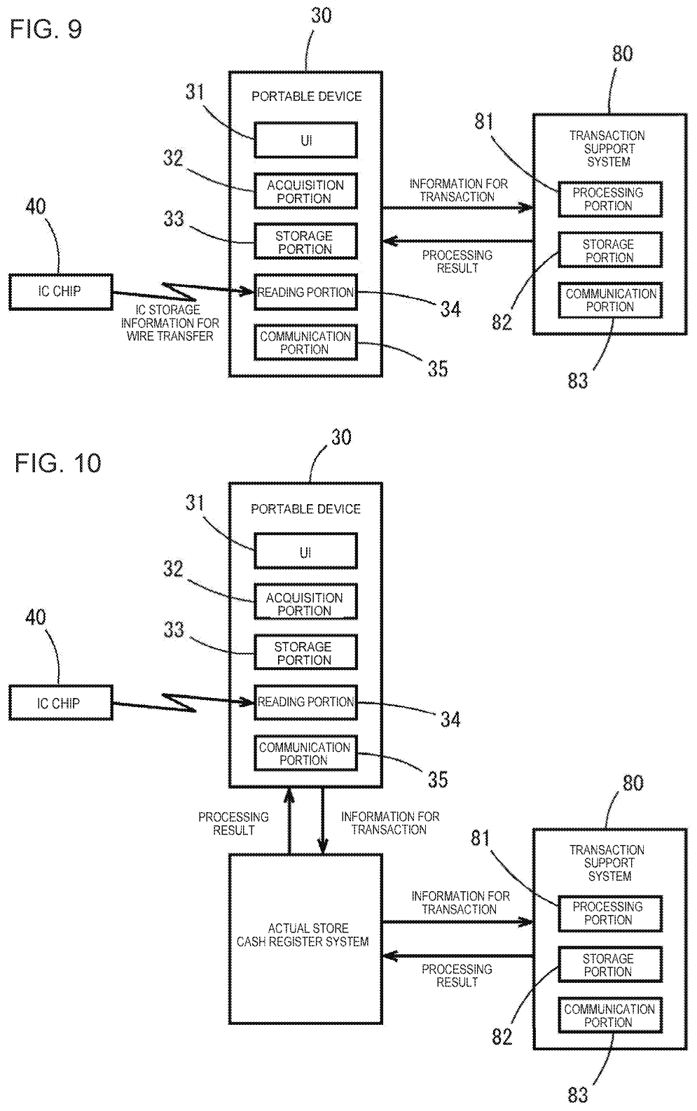

A fifth embodiment will then be described with reference to FIG. 9. In the present embodiment, the procedure of wire transfer or transfer (hereinafter simply referred to as the wire transfer procedure) is realized by the application of the first embodiment. The same parts as in the first embodiment are identified with the same reference numerals, and repeated description will be omitted. At present, in order to perform wire transfer or transfer with cash from a financial institution or the like, it takes time and effort to go to a teller window or an ATM of the financial institution or the like. In the present embodiment, an object is to perform wire transfer or transfer with cash without going to a teller window or an ATM of a financial institution or the like.

The acquisition portion 32 of the portable device 30 receives, through the UI 31, an input of wire transfer request information (information for transaction) from the user. The wire transfer request information includes the account number of a wire transfer destination, a wire transfer amount and the name or designation of the wire transfer destination. When the input of the wire transfer request information is received from the user, the acquisition portion 32 may display an image of a wire transfer form in the UI 31 so as to prompt the user to input pieces of wire transfer request information into the positions of the corresponding items in the wire transfer form. The wire transfer request information may include the address, the name or designation and the telephone number of a transferrer. The reading portion 34 may also read, from the IC chip 40, the address, the name or designation and the telephone number (IC storage information) of the transferrer. The reading portion 34 may also read the unique ID (IC storage information) of the IC chip 40 so as to acquire, from an external storage device, through the communication portion 35, the address, the name or designation and the telephone number (information for transaction) of the transferrer which are associated with the unique ID. The acquisition portion 32 stores, in the storage portion 33, the account number of the wire transfer destination, the wire transfer amount and the name or designation of the wire transfer destination and the address, the name or designation and the telephone number (information for transaction) of the transferrer which are acquired.

The acquisition portion 32 receives, through the reading portion 34, the payment of a wire transfer amount using an electronic money card. Electronic money may be a prepaid type or a post-pay type. An IC debit card may be used to perform withdrawal from an account. The reading portion 34 communicates with the IC chip 40 mounted in the electronic money card in order to pay the wire transfer amount from the electronic money, and stores, in the storage portion 33, as part of information for transaction, the IC storage information which is acquired from the IC chip 40 through the communication. The acquisition portion 32 reads the information for transaction from the storage portion 33, and transmits it through the communication portion 35 to the transaction support system 80.

The transaction support system 80 receives the information for transaction transmitted from the portable device 30, and performs, based on the information for transaction, processing for transferring the wire transfer amount paid by the electronic money to the account of the wire transfer destination.

In this way, regardless of places, the IC chip mounted in the IC card or the like can be used for wire transfer. Hence, without going to a post office, a bank or the like, the user uses a cash card with an IC, a debit card, a partnership credit card, electronic money or the like, and thereby can simply perform wire transfer at home or anywhere else.

When this mechanism is used so as to perform online shopping and payment in the second, third and fourth embodiments, bank wire transfer or postal transfer is selected as a payment method, and the fifth embodiment is performed, with the result that it is possible to easily perform bank wire transfer or the like at home or the like.

In this way, although it has so far been necessary to go to a bank to perform wire transfer or start up online banking to perform a payment when performing bank wire transfer for online shopping, it is possible to easily perform the payment as follows.

A description will be given using an example. For example, after shopping with a smart phone, bank wire transfer is selected as a payment method. When the payment reception portion 32 receives the selection of the payment method, “Place a card of oo bank.” is displayed in the UI 31. When the user of the payment terminal 30 makes the portable device 30 read an IC card or a debit card of the displayed bank while producing a bleep, the payment terminal 30 transmits payment information to a predetermined payment system 50, and thus it is possible to perform wire transfer from the back by the processing of the payment system 50. Here, the payment reception portion 32 may require the user to input a password from the UI 31, and compare the input password with a password recorded in the IC card so as to authenticate the user. Alternatively, the input password may be transmitted to a system corresponding to the bank or the like so as to authenticate the user. The authentication of the user may be performed with fingerprint authentication, iris authentication or the like other than the password.

A sixth embodiment will then be described with reference to FIG. 1. The same parts as in the first embodiment are identified with the same reference numerals, and repeated description will be omitted. Although in the second embodiment, the mechanism of the identification is described, in the present embodiment, a case where the identification system is performed as an independent service will be described in more detail.

It has so far been difficult to accurately perform identification and age verification in online shopping or the like. Hence, in a sales site for liquors, a mechanism is used in which when a display of “Are you 20 years old or older?” is produced, and the answer is “yes”, the user can buy liquors. However, it is actually difficult to check whether the user is 20 years old or older, and thus only a formality is performed. The same is true for sites which persons less than 18 years old cannot browse.

However, when the mechanism of the present embodiment is used, it is possible to perform identification. In FIG. 1, in the storage portion 82 of the transaction support system 80 (identification system), personal information such as the date of birth and the age of the user is previously registered so as to be associated with a personal identifier. The personal information may be registered in an external storage device. Then, when a browsing site and a shopping site are browsed with the portable device 30 such as a smart phone, the acquisition portion 32 of the portable device 30 displays, for example, a condition of “Are you 20 years old or older? in the UI 31. The user of the portable device 30 operates the UI 31 so as to select “yes”. The acquisition portion 32 which has received this selection produces, in the UI 31, a display of “Please read the IC card.” for requiring the user to read information from the IC chip 40. When the user makes the IC chip 40 of the IC card storing the personal identifier approach the reading portion 34 of the portable device 30, the acquisition portion 32 acquires, through the reading portion 34, the personal identifier (such as a card number) stored in the IC chip 40, and transmits, through the communication portion 35, the acquired personal identifier to the transaction support system 80 (identification site). The processing portion 81 of the transaction support system 80 receives the personal identifier from the portable device 30 so as to acquire the date of birth or the age associated with the received personal identifier from the storage portion 82 or the external storage device. When the date of birth is acquired, it may be converted into the current age based on the current day. Then, when the registered information satisfies, for example, the condition in which the user is 20 years old or older, the processing portion 82 transmits information indicating “browsing is allowed” and “purchasing is allowed” to a browsing site and a purchasing site. The processing portion 82 also transmits, to the browsing site and the purchasing site, a status of “20 years old or older” and the acquired information such as the date of birth and the age so that the browsing site and the purchasing site can determine the conditions of “browsing is allowed” and “purchasing is allowed”. In this way, only users who satisfy the condition are allowed to perform browsing or purchasing. In the configuration described above, the transaction support system 80 may receive, from the portable device 30, the personal information read from the IC chip 40 so as to acquire the personal information.

The same method allows a discount or the like corresponding to the age of an elderly person or a young person which is difficult to check in online shopping.

In the mechanism described above, the IC card does not necessarily need to be a card with a payment function, and may be a citizen card or the like. Hence, separate cards may be used, and in an example of such a case, identification is performed with a citizen card or the like and payment is performed with a payment card. In this case, the payment agency system and the identification system may be separate from each other.

The following configuration may also be adopted. The name, the address and the like of the user are previously registered in the storage portion 82 of the identification system 80 or an external storage device so as to be associated with the personal identifier, the portable device 30 reads the personal identifier from the IC chip 40 and transmits it to the identification system 80, the processing portion 81 of the identification system 80 acquires, from the storage portion 82 or the external storage device, the name, the address and the like associated with the personal identifier received from the portable device 30 and the name, the address and the like which are acquired are transmitted to the portable device 30 or the shop system so as to be automatically input to the order form of a commodity or the like.

A seventh embodiment will then be described with reference to FIG. 1. The same parts as in the first embodiment are identified with the same reference numerals, and repeated description will be omitted. In the present embodiment, the portable device 30 reads, as information for transaction, personal information such as an address, a name and the like from IC storage information stored in the IC chip 40 so as to utilize it for various types of transactions.

In FIG. 1, the portable device 30 acquires, as the information for transaction, the personal information read from the IC chip 40, and transits the personal information to the transaction support system 80. The transaction support system 80 utilizes the personal information received from the portable device 30 for processing necessary for performing transactions.

The IC card in which the IC chip 40 is mounted is a card in which personal information is stored in the IC chip 40, and for example, a citizen card, my number card or the like can be used. A dedicated IC card for inputting personal information may be used. Personal information which is stored in a payment card may also be read and utilized. Personal information associated with the identifier of a payment card may also be read from an external personal information database so as to be utilized.

When a transaction is performed, the user of the portable device 30 makes the reading portion 34 of the portable device 30 read the personal information stored in the IC chip 40. The acquisition portion 32 stores, in the storage portion 33, as the information for transaction, the personal information received by the reading portion 34. The acquisition portion 32 receives, as necessary, an input of the personal information through the UI 31 from the user, and stores it in the storage portion 33. Then, the acquisition portion 32 reads the personal information stored in the storage portion 33, and transmits it through the communication portion 35 to the transaction support system 80.

The processing portion 81 of the transaction support system 80 acquires, through the communication portion 83, the personal information transmitted from the portable device 30, and stores it in the storage portion 82. Thereafter, the processing portion 81 may utilize the personal information stored in the storage portion 82 so as to perform predetermined processing necessary for performing the transaction, and transmit the result of the processing through the communication portion 83 to the portable device 30 which is the transmission source of the personal information.

Specifically, the portable device 30 may acquire the personal information such as the address and the name from the IC chip 40, and the transaction support system 80 may perform, based on the personal information, application processing for a hometown tax payment. For example, tablet terminals serving as the portable devices 30 are distributed within a vehicle to participants in a bus tour, and thus it is possible to ask the participants to apply for a hometown tax payment within the vehicle. Payments may be collected.

In the present embodiment, an IC card or the like is made to touch a card reader incorporated in a smart phone, a tablet terminal or the like so as to input personal information such as an address, and thus the personal information can be utilized for transactions.

An eighth embodiment of the present invention will then be described with reference to FIG. 10. The same parts as in FIG. 1 are identified with the same reference numerals, and repeated description will be omitted. In the present embodiment, the portable device 30 communicates with the transaction support system 80 through a cash register system 100 installed in an actual store. A consumer performs, in the actual store, the payment of the price of a commodity or the like which is purchased.

The portable device 30 is a smart phone or a tablet terminal. The cash register system 100 in the actual store may be formed with a plurality of devices which communicate with each other. The cash register system in the actual store may have a POS function. The portable device 30 may be a device carried by the consumer or a device of the store. When the portable device 30 is the device carried by the consumer, the portable device 30 preferably communicates with the cash register system 100 wirelessly. On the other hand, when the portable device 30 is the device of the store, the portable device 30 may communicate with the cash register system 100 by wire. Although some methods for wireless communication between the portable device 30 and the cash register system 100 can be considered, methods by Wi-Fi and Bluetooth (registered trademark) can be considered. As a method of establishing connection between the portable device 30 and the cash register system 100, a method may be adopted in which the portable device 30 scans a two-dimensional barcode so as to uniquely identify the device of the cash register system which is connected. A method may also be adopted in which a password or a one-time password corresponding to a transaction is input from the portable device 30, and in which thus device authentication between the portable device 30 and the cash register system 100 is performed.

The consumer checks, with the display portion of the cash register system 100, the price of the commodity or the like which is purchased. Alternatively, the consumer checks, with the UI 31 of the portable device 30, the price transmitted from the cash register system 100 to the portable device 30. When the price is correct, the consumer makes the IC chip 40 of a payment card touch the reading portion 34 of the portable device 30. The portable device 30 transmits, through the reading portion 34, to the cash register system 100, information for transaction such as a credit card number read from the IC chip 40. The cash register system 100 transmits, to the transaction support system 80, the information for transaction and the purchase price received from the portable device 30 so as to make the transaction support system 80 perform processing for the credit card payment. When the cash register system 100 receives the information of the result of the payment from the transaction support system 80, the cash register system 100 may transmit the information of the result of the payment to the portable device 30, and the result of the payment may be displayed in the UI 31 of the portable device 30. Until the completion of the payment, the consumer inputs the password of the payment card from the UI 31 of the portable device 30 so as to perform identification.

In the present embodiment, a credit card or the like is made to touch the portable device 30 so as to be able to perform a payment without being passed to a clerk, and thus it is possible to protect information for transaction displayed in the credit card or the like.

Here, the scope of the present invention is not limited to the embodiments described above. The scope of the present invention is the scope of the invention based on the scope of claims.

### EXPLANATION OF THE REFERENCE NUMERALS

10 shopping terminal

11 shopping processing portion

20 shop system

30 payment terminal (portable device)

31 UI (user interface)

32 payment reception portion (transaction portion)

33 storage portion

34 reading portion

35 communication portion

40 IC card (IC chip)

50 payment system

60 card company system

70 information provision system

80 payment agency system (transaction support system)

81 payment processing portion (processing portion)

82 storage portion

83 communication portion

90 shopping terminal and payment terminal

100 actual store cash register system

1. A non-transitory computer-readable storage medium storing a transaction support program for a portable device, wherein the transaction support program for the portable device, when executed, causes a processor to perform operations comprising:
reading, with a reading portion incorporated in the portable device, IC storage information stored in an external IC chip;
acquiring information for transaction with an acquisition portion; and
transmitting, with a communication portion, the information for transaction to an external transaction support system so as to perform a transaction, wherein
in the acquiring of the information for transaction, at least part of the information for transaction is acquired based on the IC storage information read with the reading portion.

2. A non-transitory computer-readable storage medium storing a transaction support program for a portable device, wherein the transaction support program for the portable device, when executed, causes a processor to perform operations comprising:
reading, with a reading portion incorporated in the portable device, IC storage information for price payment stored in an external IC chip;
acquiring information for transaction with an acquisition portion; and
transmitting, with a communication portion, the information for transaction to an external transaction support system so as to perform a payment of a price, wherein
in the acquiring of the information for transaction, at least part of the information for transaction is acquired based on the IC storage information for price payment read with the reading portion.

3. The non-transitory computer-readable storage medium storing the transaction support program for a payment device according to claim 2, wherein the operation of transmitting the information for transaction comprises
receiving a payment request for a price of a commodity purchased with an external shopping terminal through the communication portion, and
transmitting the information for transaction to the external transaction support system so as to perform a payment of the price.

4. A transaction support system comprising:
a communication portion, which receives an identifier of a purchaser who purchases a commodity by utilization of a shop system;
a storage portion, which stores the identifier of the purchaser received by the communication portion; and
a processing portion, which acquires contact information of a payer that is associated with the identifier of the purchaser, wherein
the processing portion transmits, through the communication portion, a payment request for a price purchased to a payment device, which corresponds to the contact information and, which executes the program according to claim 2.

5. The transaction support system according to claim 4, wherein
the communication portion receives an identifier of the payer from the payment device that receives the payment request,
the storage portion stores the identifier of the payer that is received and
the processing portion acquires, from an internal or external storage device, an identifier of a true payer, which is previously associated with the identifier of the purchaser, and allows a payment procedure from the payment device in response to determining that the identifier of the payer received from the payment device agrees with the identifier of the true payer.

6. A non-transitory computer-readable storage medium storing a transaction support program for a portable device, wherein the transaction support program for the portable device, when executed, causes a processor to perform operations comprising:
reading, with a reading portion incorporated in the portable device, IC storage information for identification stored in an external IC chip;
acquiring information for transaction with an acquisition portion; and
transmitting, with a communication portion, the information for transaction to an external transaction support system so as to perform identification, wherein
in the acquiring of the information for transaction, at least part of the information for transaction is acquired based on the IC storage information for identification read with the reading portion.

7. A transaction support system comprising a communication portion, which receives the information for transaction from the portable device that executes the program according to claim 6, wherein
whether a person possessing the IC chip is the true payer is determined based on the received information for transaction, and a procedure from the portable device is allowed on condition that the person possessing the IC chip is the true payer.

8. The transaction support system according to claim 7, wherein
the communication portion receives personal information included in the information for transaction, and
a processing portion acquires a bonus condition from an internal or external storage device, and acquires, when the received personal information satisfies the bonus condition, a bonus associated with the bonus condition from the internal or external storage device so as to apply the bonus to the procedure from the portable device.

9. A transaction support system comprising:
a communication portion, which receives, from the portable device executing the program according to claim 1, an identifier of the portable device and an identifier of the IC chip; and
a processing portion, which acquires, from an internal or external storage device, association of an identifier of a portable device and an identifier of an IC chip that is previously registered, wherein
the processing portion allows a procedure from the portable device in response to determining that a combination of the identifier of the portable device and the identifier of the IC chip which are received agrees with a combination of the identifier of the portable device and the identifier of the IC chip that is acquired from the storage device.

10. The non-transitory computer-readable storage medium storing the transaction support program according to claim 2, wherein the transaction support program, when executed, causes the processor to perform operations further comprising:
receiving, with the communication portion, a result of the payment from the transaction support system; and
passing, with the acquisition portion, the result of the payment to a process of shopping causing the payment of the price so as to display the result of the payment.

11. The non-transitory computer-readable storage medium storing the transaction support program according to claim 10, wherein the process of shopping causing the payment of the price comprises a process performed outside the portable device.

12. A non-transitory computer-readable storage medium storing a transaction support program for a portable device, wherein the transaction support program for the portable device, when executed, causes a processor to perform operations comprising:
reading, with a reading portion incorporated in the portable device, IC storage information for transfer or wire transfer stored in an external IC chip;
acquiring information for transaction with an acquisition portion; and
transmitting, with a communication portion, the information for transaction to an external transaction support system so as to perform wire transfer or transfer, wherein
in the acquiring of the information for transaction, at least part of the information for transaction is acquired based on the IC storage information for wire transfer or transfer read with the reading portion.

13. The transaction support system according to claim 4, wherein the purchaser is different from the payer.

14. A transaction support system comprising:
a communication portion which receives, from the portable device executing the program according to claim 1, the information for transaction; and
a processing portion which acquires personal information based on the information for transaction received by the communication portion, wherein
the processing portion determines whether or not the acquired personal information satisfies a condition of provision of a commodity or service acquired from a storage portion or an external storage device, and transmits a result of the determination through the communication portion to an external system.

15. A transaction support system comprising:
a communication portion which receives, from the portable device executing the program according to claim 1, the information for transaction; and
a processing portion which acquires personal information based on the information for transaction received by the communication portion, wherein
the processing portion transmits the acquired personal information through the communication portion to an external system so as to make the external system determine whether or not the personal information satisfies a condition of provision of a commodity or service.

16. The non-transitory computer-readable storage medium storing the transaction support program according to claim 1, wherein as the IC storage information, personal information such as an address is read, and the personal information is included in the information for transaction.

17. The non-transitory computer-readable storage medium storing the transaction support program according to claim 1, wherein in the transmitting the information for transaction, the information for transaction is transmitted to a cash register system in an actual store instead of the transaction support system.
